(19) United States
(12) Patent Application Publication
(10) Pub. No.: US 2017/0324573 A1
(43) Pub. Date: Nov. 9, 2017

(54) INFORMATION PRESENTATION METHOD, APPARATUS AND SYSTEM

(71) Applicant: Alibaba Group Holding Limited, Grand Cayman (KY)

(72) Inventor: Jun Peng, Zhejiang (CN)

(21) Appl. No.: 15/659,471

(22) Filed: Jul. 25, 2017

Related U.S. Application Data
(63) Continuation of application No. PCT/CN2016/072465, filed on Jan. 28, 2016.

(30) Foreign Application Priority Data
Feb. 3, 2015 (CN) CN201510057331.3

(51) Int. Cl. H04L 12/18; H04M 3/56

(52) U.S. Cl. CPC H04L 12/1827; H04M 3/567

(57) ABSTRACT

An information presentation method for resolving the problem of low sharing efficiency of a file operation process between a local user and a remote user in a teleconference process. The method mainly includes: obtaining screen projection information of a local terminal, wherein the screen projection information is information currently displayed on a display screen of the local terminal; and combining the screen projection information and multimedia information collected by an information collection device into a data stream, and then sending the data stream to a receiving end for presentation. The present disclosure also provides an information presentation apparatus and system.

### CROSS REFERENCE TO RELATED PATENT APPLICATIONS

This application claims priority to and is a continuation of PCT Patent Application No. PCT/CN2016/072465, filed on 28 Jan. 2016, which claims priority to Chinese Patent Application No. 201510057331.3, filed on 3 Feb. 2015, entitled “INFORMATION PRESENTATION METHOD, APPARATUS AND SYSTEM,” which are hereby incorporated by reference in their entirety.

### TECHNICAL FIELD

The present disclosure relates to the field of computer technologies, and in particular, to an information presentation method, apparatus and system.

### BACKGROUND

With the continuous development of network technologies, local users are able to perform a teleconference with a remote user through various terminals. The “teleconference” is generally divided into two types: a remote video conference and a remote telephone conference.

In a teleconference process, a user may have information sharing demands. For example, a local user may desire to share a demonstration process of a file with a remote user. By taking a remote video conference as an example, in conventional techniques, sharing of a demonstration process of a file by a local user and a remote user in the remote video conference may be implemented in the following manner:

an information collection device (e.g., a camera and a microphone) of the local user collects local multimedia information (including audio information and video information), and sends, through a local terminal (a mobile phone, a Personal Computer (PC), a smart television or the like), the multimedia information to a presentation device 1 of the remote user for presentation;

the local terminal acquires a file to be demonstrated by the local user, and sends the file to a presentation device 2 of the remote user for display; and

the remote user manually demonstrates, based on the multimedia information presented by the presentation device 1, the file on the presentation device 2 under the voice control of the local user.

The conventional techniques have the following problem: sharing of the demonstration process of the file needs manual cooperation of the remote user, and therefore, the sharing efficiency of the demonstration process of the file is relatively low.

Similarly, the above manner may also result in relatively low sharing efficiency of other operation processes of the file between the local user and the remote user. The other operations here may include, but are not limited to, any presentable operation performed on the file, for example, modification of the name of the file, modification of content of the file, deletion of the file, and so on.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

The present disclosure discloses a method, from a perspective of a first terminal, comprising:

outputting, by a first terminal, a screen projection code mapped to the first terminal;

receiving a screen projection request sent by a second terminal,

establishing a connection between the first terminal and the second terminal.

For example, the first terminal includes a first computer, a smart TV, a set-top box, or a projector; and the second terminal includes a second computer or a portable device.

For instance, a connection application may be installed on both the first terminal and the second terminal. The first terminal generates the screen projection code per protocol of the connection application. The screen projection code may be an address that locates the first terminal such as Internet Protocol (IP) address or a Media Access Control (MAC) address of the first terminal or a code or alias corresponding to such address. The second terminal may convert the screen projection code to the address of the first terminal according to protocol of the connection application.

For another instance, both the first terminal and the second terminal may communicate with a server. The server converts the address of the first terminal to the screen projection code and, upon receiving a request from the second terminal, converts the screen projection code to the address of the first terminal and send it to the second terminal.

For example, the outputting the screen projection code mapped to the first terminal includes:

generating, by the first terminal, the screen projection code; and

displaying the screen projection code on a screen of the first terminal.

The screen projection code may be unchanged for a preset period of time or generated each time with a new code for a new connection.

For another example, the outputting the screen projection code mapped to the first terminal includes:

receiving, by the first terminal, the screen projection code from a server; and

displaying the screen projection code on a screen of the first terminal.

For example, the outputting the screen projection code mapped to the first terminal includes broadcasting the screen projection code. The first terminal may broadcast the screen projection code via wireless technologies, such as Bluetooth or Wifi.

For example, the method may further comprise:

receiving screen projection information of the second terminal; and

displaying the screen projection information at a screen of the first terminal.

The screen projection information may be information currently displayed on the second terminal or information that the second terminal is to be projected onto the screen of the first terminal.

For example, the method may further comprise:

receiving a data stream including screen projection information of the second terminal and multimedia information collected by an information collection device; and

displaying the data stream at the screen of the first terminal.

For instance, the multimedia information is video information when there is a remote video conference between the first terminal and the second terminal. The video information may capture a user's action in a preset distance and range to the second terminal device.

Both the first terminal and the second terminals may be local terminals, such as they are in the same room, or remote to each other, such as the first terminal is located in Hangzhou, China and the second terminal is located in Seattle, US. Whether the first terminal and second terminal may be dependent on a distance between the first terminal and the second terminal. If the distance between the first terminal and the second terminal is smaller than a threshold, they are local terminals. If distance between the first terminal and the second terminal is larger than a threshold, they are remote terminals to each other. The threshold may be a transmission threshold, such as a maximum Wifi or Bluetooth transmission rage, or any other preset threshold

The present disclosure also discloses another method, from a perspective of the second terminal, comprising:

receiving a first screen projection code mapped to a first terminal by a second terminal;

determining the first terminal according to the first screen projection code;

sending a first screen projection request from the second terminal to the first terminal;

and establishing a first connection between the first terminal and the second terminal.

For example, the method may further comprise:

obtaining screen projection information of the second terminal device;

obtaining multimedia information collected by an information collection device;

combining the screen projection information and multimedia information into a data stream; and

sending the data stream to the first terminal.

For example, the combining the screen projection information and the multimedia information into the data stream includes:

combining, according to a relative position relationship between a picture represented by the screen projection information and a picture represented by the multimedia information, the screen projection information and the multimedia information collected by the information collection device into the data stream.

The second terminal may project screen projection information onto multiple terminals. For example, the method may further comprise:

receiving a second screen projection code mapped to a third terminal by a second terminal;

determining the third terminal according to the second screen projection code;

sending a second screen projection request from the second terminal to the third terminal; and

establishing a second connection between the first terminal and the second terminal.

For example, the establishing the second connection between the first terminal and the second terminal includes establishing the first connection and the second connection concurrently. combining the screen projection information into a data stream, and then sending the data stream to a receiving end for presentation.

For example, a distance between the first terminal and the second terminal is smaller or larger than a threshold.

The present disclosure also provides an apparatus comprising:

one or more processors; and

one or more memories stored thereon computer readable instructions that, when executed by one or more processors, cause the one or more processors to perform acts comprising:
outputting, by a first terminal, a screen projection code mapped to the first terminal;
receiving a screen projection request sent by a second terminal,
establishing a connection between the first terminal and the second terminal;
receiving screen projection information of the second terminal; and
displaying the screen projection information at a screen of the first terminal.

In addition, example embodiments of the present disclosure also provide an information presentation method for solving the problem of low sharing efficiency of a file operation process between a local user and a remote user in a teleconference process.

The example embodiments of the present disclosure further provide an information presentation apparatus for solving the problem of low sharing efficiency of a file operation process between a local user and a remote user in a teleconference process.

The example embodiments of the present disclosure further provide an information presentation system, for solving the problem of low sharing efficiency of a file operation process between a local user and a remote user in a teleconference process.

The example embodiments of the present disclosure adopt the following technical solutions:

An information presentation method, including:
obtaining screen projection information of a local terminal, wherein the screen projection information is information currently displayed on a display screen of the local terminal; and combining the screen projection information and multimedia information collected by an information collection device into a same data stream, and then sending the data stream to a receiving end for presentation.

An information presentation method, including:

obtaining a data stream including screen projection information and multimedia information; and presenting the screen projection information and the multimedia information.

An information presentation apparatus, including:

an acquisition unit configured to obtain screen projection information of a local terminal, wherein the screen projection information is information currently displayed on a display screen of the local terminal; and

a sending unit configured to combine the screen projection information and multimedia information collected by an information collection device into a same data stream, and then send the data stream to a receiving end for presentation.

An information presentation apparatus, including:

an acquisition unit configured to obtain a data stream including screen projection information and multimedia information; and

a presentation unit configured to present the screen projection information and the multimedia information.

An information presentation system, including:

a first device configured to present a screen projection code mapped to an address of the first device; and after receiving and responding to a screen projection request sent by a second device, perform information presentation according to a data stream sent by the second device; and

the second device configured to obtain the screen projection code; and send a screen projection request to the first device after the address mapped by the screen projection code is determined; and after the first device responds to the screen projection request, combine the screen projection information and multimedia information collected by an information collection device into the data stream and send the data stream to the first device;

wherein the screen projection information is information currently displayed on a display screen of a local terminal.

An information presentation method, including:

presenting a screen projection code mapped to a local address; and

performing, after receiving and responding to a screen projection request sent by another terminal, information presentation according to a data stream sent by the another terminal;

wherein the data stream includes screen projection information and multimedia information collected by an information collection device; and

the screen projection information is information currently displayed on a display screen of the another terminal.

An information presentation method, including:

obtaining a screen projection code;

sending, after a local address mapped by the screen projection code is determined, a screen projection request to a device corresponding to the local address; and

combining, after the device responds to the screen projection request, the screen projection information and multimedia information collected by an information collection device into a data stream and sending the data stream to the device.

An information presentation apparatus, including:

a presentation unit configured to present a screen projection code mapped to a local address; and

a receiving unit configured to perform, after receiving and responding to a screen projection request sent by another terminal, information presentation according to a data stream sent by the another terminal;

wherein the data stream includes screen projection information and multimedia information collected by an information collection device; and the screen projection information is information currently displayed on a display screen of the another terminal.

An information presentation apparatus, including:

an acquisition unit configured to obtain a screen projection code;

a determination unit configured to send, after determining a local address mapped by the screen projection code, a screen projection request to a device corresponding to the local address; and

a sending unit configured to combine, after the device responds to the screen projection request, the screen projection information and multimedia information collected by an information collection device into a data stream and send the data stream to the device.

For brevity, some example methods, apparatuses, or embodiments are not described in detail, the details of which may refer to other methods, apparatuses, or embodiments, unless there is a contradiction.

The above at least one technical solution adopted by the example embodiments of the present disclosure may achieve the following beneficial effects:

Information currently displayed on a display screen of a local terminal and multimedia information collected by an information collection device are combined into a same data stream, and the data stream is sent to a receiving end for presentation. Therefore, when the solution is applied to a teleconference process, automatic sharing of a file operation process is achieved while transmission of the multimedia information is supported, which does not require manual cooperation of a remote user and solves the problem of relatively low sharing efficiency of the file operation process between a local user and a remote user in the teleconference process.

### BRIEF DESCRIPTION OF THE DRAWINGS

The accompanying drawings described herein are used to provide further understanding about the present disclosure, and constitute a part of the present disclosure. Schematic example embodiments of the present disclosure and description thereof are intended to explain the present disclosure and do not pose any improper limitation to the present disclosure. In the accompanying drawings:

FIG. 1 is a flowchart of an information presentation method according to example embodiment 1 of the present disclosure;

FIG. 2 is a flowchart of an information presentation method according to example embodiment 2 of the present disclosure;

FIG. 3 is a method of real-time demonstrating a “file operation” process to a remote user in a remote video conference according to example embodiment 3 of the present disclosure;

FIG. 4 is a structural diagram of an information presentation apparatus according to example embodiment 4 of the present disclosure;

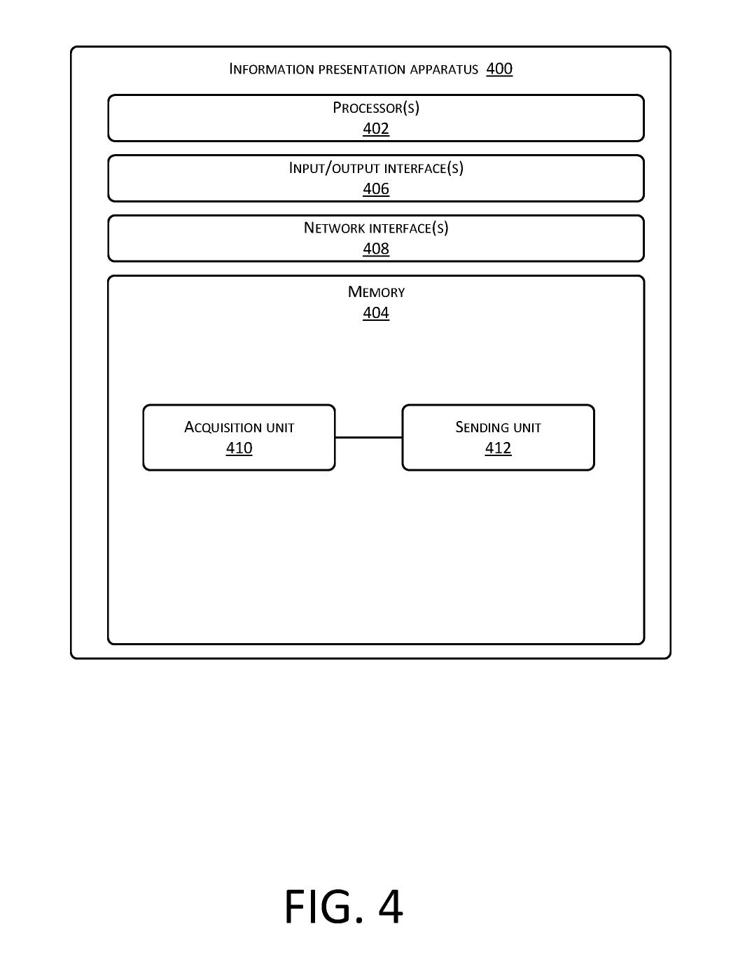

FIG. 5 is a structural diagram of an information presentation apparatus according to example embodiment 5 of the present disclosure;

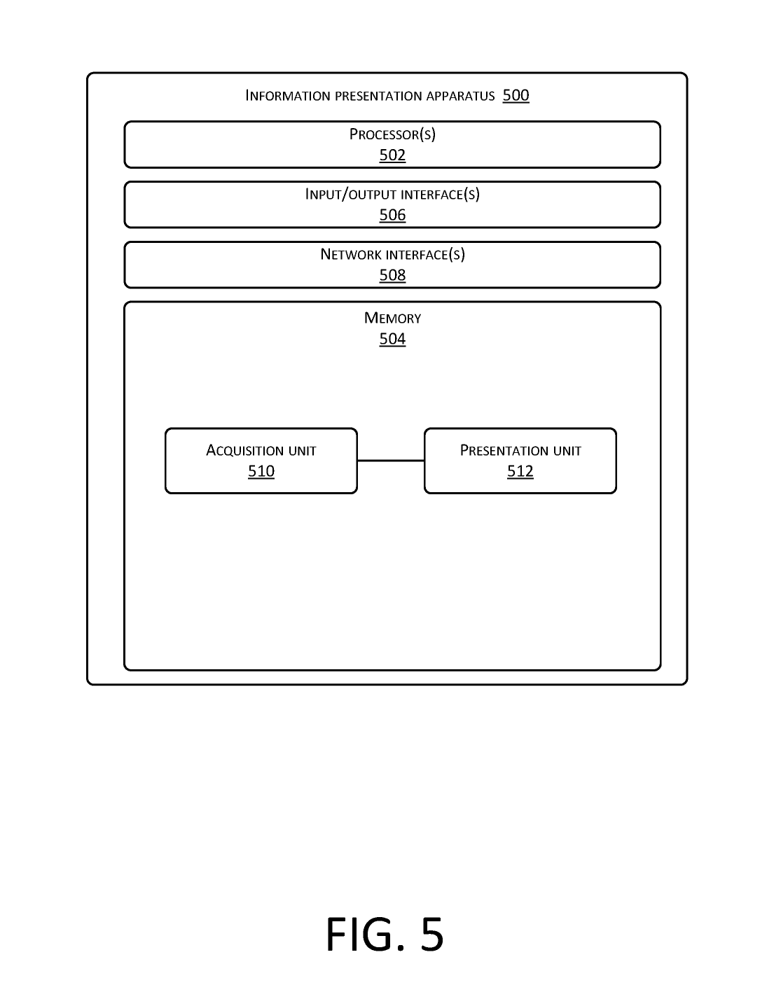

FIG. 6 is a structural diagram of an information presentation system according to example embodiment 6 of the present disclosure;

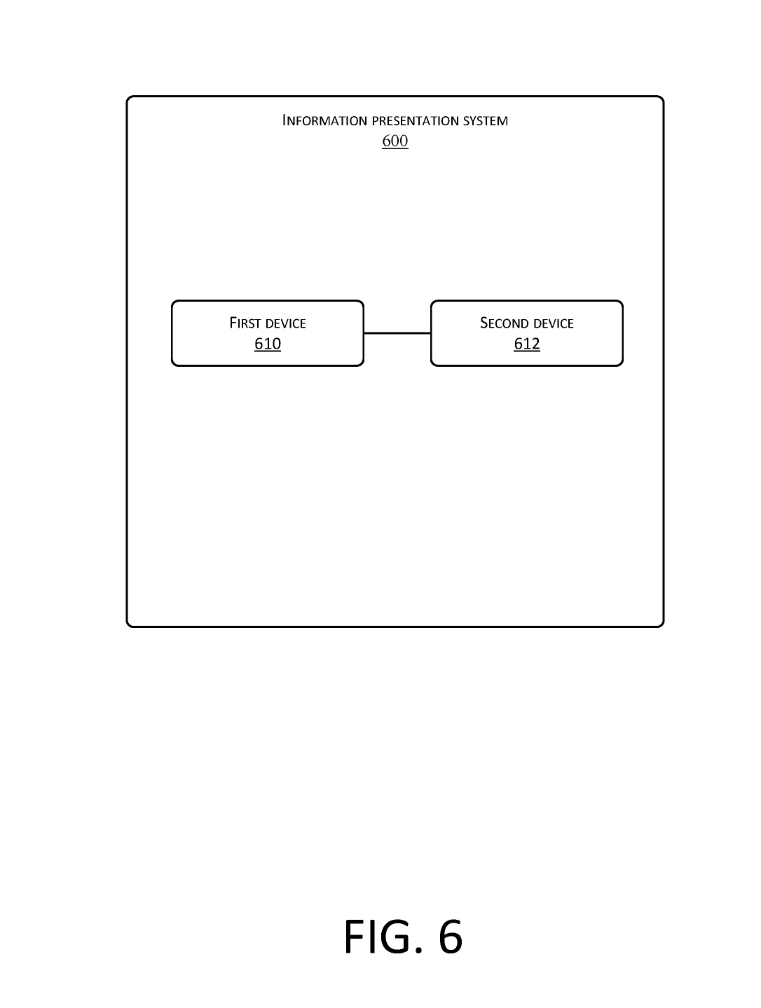

FIG. 7 is a flowchart of an information presentation method according to example embodiment 7 of the present disclosure;

FIG. 8 is a flowchart of an information presentation method according to example embodiment 8 of the present disclosure;

FIG. 9 is a structural diagram of an information presentation apparatus according to example embodiment 9 of the present disclosure; and

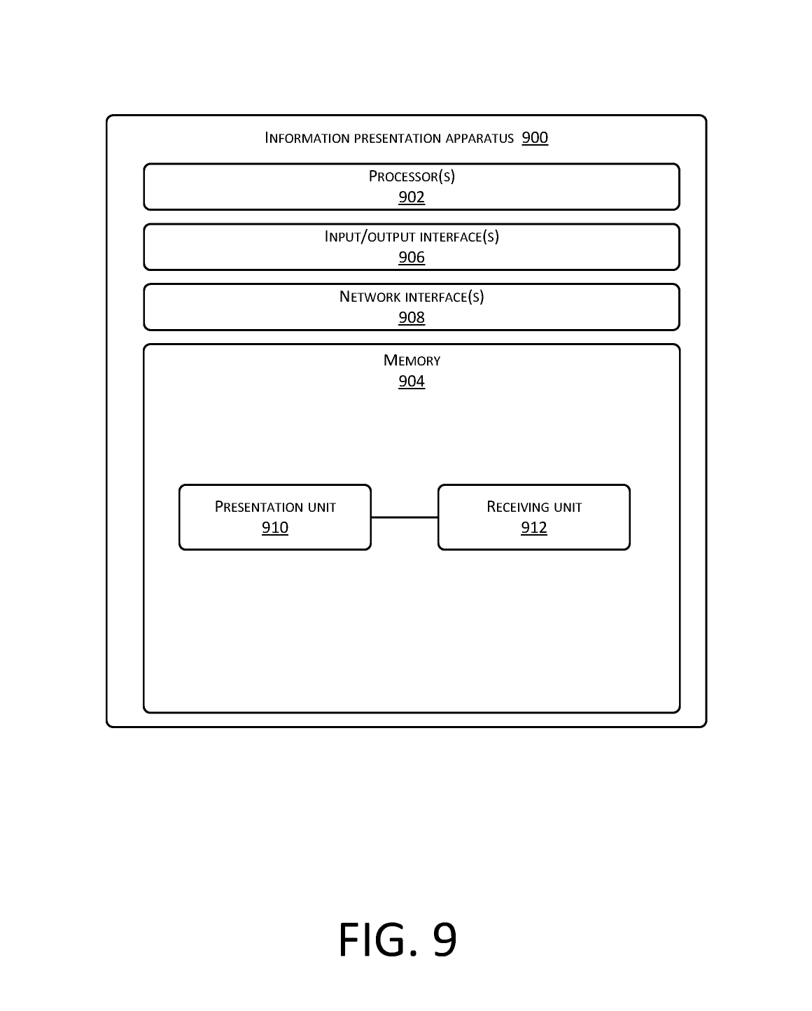

FIG. 10 is a structural diagram of an information presentation apparatus according to example embodiment 10 of the present disclosure.

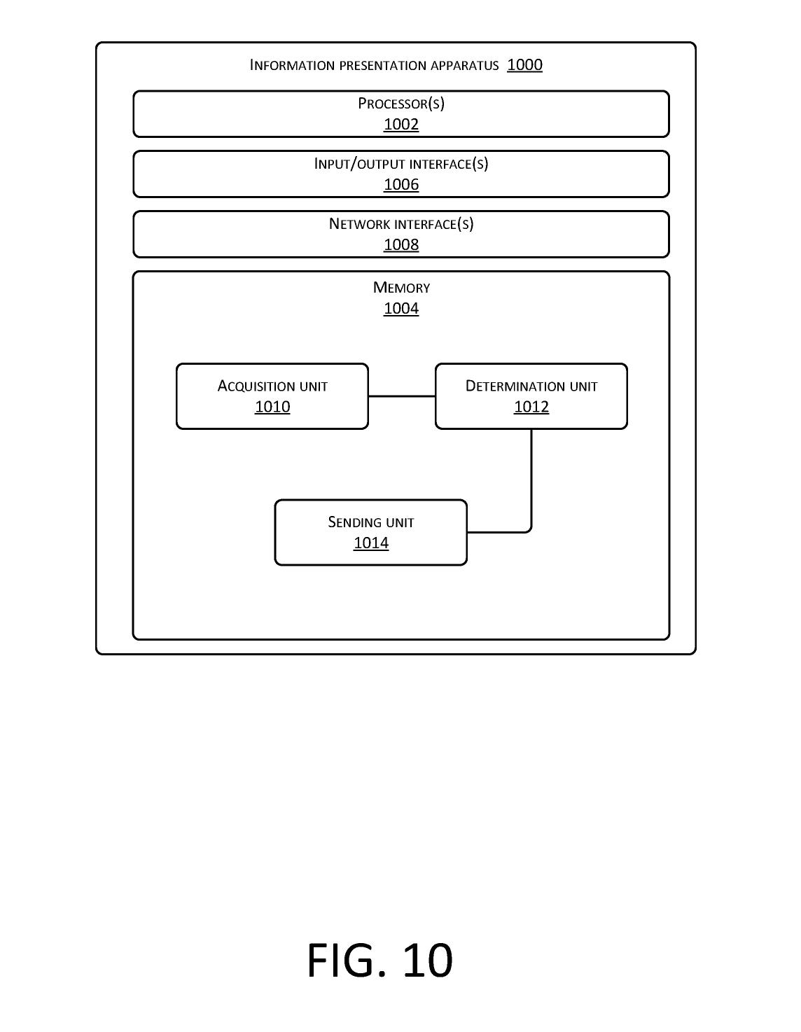

### DETAILED DESCRIPTION

To make the objectives, technical solutions, and advantages of the present disclosure clearer, the technical solutions of the present disclosure are clearly and completely described in the following with reference to specific example embodiments and corresponding accompanying drawings of the present disclosure. It is apparent that the example embodiments described are merely some of rather than all of the example embodiments of the present disclosure. All other example embodiments obtained by those of ordinary skill in the art based on the example embodiments in the present disclosure without paying creative efforts all belong to the protection scope of the present disclosure.

The technical solutions provided in various example embodiments of the present disclosure are described in detail in the following with reference to the accompanying drawings.

### Example Embodiment 1

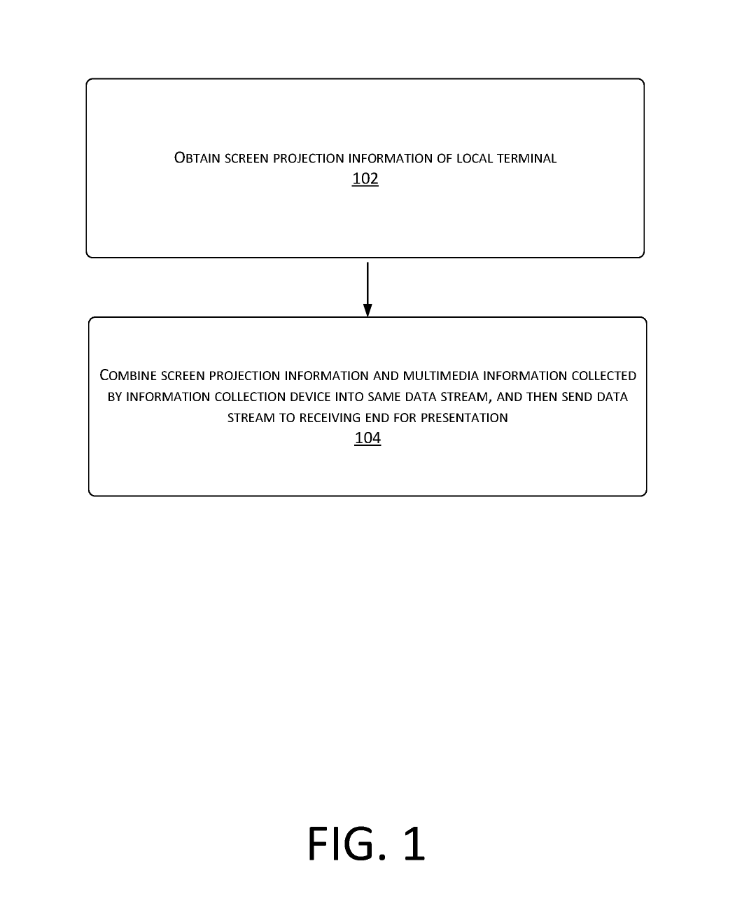

In order to solve the problem of relatively low sharing efficiency of the file operation process between a local user and a remote user in a teleconference process, example embodiment 1 of the present disclosure first provides an information presentation method. The method may be performed by a smart television, a set-top box, a PC or the like, and the present disclosure makes no limitation. A flowchart of implementation of the method is as shown in FIG. 1, which mainly includes the following steps:

Step 102. Screen projection information of a local terminal is obtained.

The screen projection information may be information currently displayed on a display screen of the local terminal. For example, the screen projection information may be a process of operating an Office document currently demonstrated by a user on a PC, or a process of currently editing an image by a user on a mobile phone, and so on. The screen projection information may be obtained, according to a preset sampling cycle, by collecting information displayed on the display screen of the local terminal.

In the example embodiment of the present disclosure, the screen projection information may be acquired by adopting a millisecond-scale screen shot cycle, to support acquisition of screen projection information corresponding to a demonstration process of a file such as an office file, and then the demonstration process is synchronized to a receiving end through subsequent steps.

Step 104. The obtained screen projection information of the local terminal and multimedia information collected by an information collection device are combined into a same data stream, and then the data stream is sent to a receiving end for presentation.

The combining the obtained screen projection information of the local terminal and multimedia information collected by an information collection device into a same data stream may refer to receiving screen projection information and multimedia information respectively from different signal channels, and then fitting the screen projection information and the multimedia information received from different signal channels into a data stream, and the data stream is sent to a receiving end via a single signal channel.

In an implementation, the screen projection information and the multimedia information collected by the information collection device may be combined into a same data stream by using a Real-time Transport Protocol (RTP). That is, the screen projection information and the multimedia information may be encapsulated into the data stream by using the RTP.

In an implementation, when the multimedia information is a picture, a sending end of the data stream may superimpose, according to a relative position relationship (the relationship may be preset in the sending end) between the picture and a picture corresponding to the screen projection information, the picture and the picture corresponding to the screen projection information to form a new picture, and then a data stream is generated by using data of the new picture and sent. Subsequently, a receiving end of the data stream may present the new picture according to the data stream.

Here, it should be noted that, the format of the data of the new picture may be converted, in a manner such as openh264 soft coding and/or display hardware decoding, to an information presentation format that the receiving end can support, and then the data stream is sent to the receiving end for presentation.

In an implementation, after the obtained screen projection information of the local terminal and the multimedia information collected by the information collection device are combined into a same data stream, the execution body may send the data stream to a remote terminal for presentation, or send the data stream to another local terminal for presentation; or may send the data stream to another local terminal, and the another local terminal forwards the data stream to a remote terminal for presentation. The information collection device may be built in the local terminal, or may be a separate third-party device.

In an implementation, step 102 may be performed during a teleconference. That is, the screen projection information of the local terminal is obtained during a teleconference. The multimedia information is video information when the teleconference is a remote video conference.

By using the method provided in example embodiment 1, information currently displayed on a display screen of a local terminal and multimedia information collected by an information collection device can be combined into a same data stream, and the data stream is sent to a receiving end for presentation. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

In an implementation, in order to facilitate the execution body to establish a connection with the local terminal rapidly, before step 102, the process shown in FIG. 1 may further include step A1 to step A3 as follows (not shown in FIG. 1):

Step A1. A screen projection code mapped to a local address is output.

The screen projection code may be input by displaying the screen projection code on a display device; or broadcasting the screen projection code through the display device. The screen projection code may be characters such as digits and/or letters. The local address may be an Internet Protocol Address (IP address).

Step A2. A screen projection request sent by the local terminal after the local terminal determines the local address according to the screen projection code is received.

Step A3. A connection with the local terminal is established in response to the screen projection request.

In an implementation, step 102 may be implemented through step B1 to step B3 as follows (not shown in FIG. 1):

Step B1. A screen projection request sent by the local terminal is received.

Step B2. It is judged whether screen projection information provided by another local terminal is received currently.

Step B3. Screen projection information provided by the local terminal is received when the judgment result is No.

In the following, that step B1 to step B3 are performed by a smart television is taken as an example for description:

By taking that step B1 to step B3 are performed by a smart television as an example, when the smart television currently does not receive any screen projection information sent by the local terminal, the smart television may display the screen projection information on a screen if the local terminal sends a screen projection request to the smart television at this point. Otherwise, if the smart television currently displays screen projection information sent by another local terminal, at this point, the smart television may present corresponding prompt information to a user of the local terminal, for example, words such as “whether to switch current video information” or “not receive the screen projection information” are prompted to the user of the local terminal.

It should be noted that the steps of the method provided in example embodiment 1 may all be performed by a same device, or the method may also be performed by different devices. For example, step 102 may be performed by a device 1, and step 104 may be performed by a device 2; for another example, step 104 may be performed by a device 1, and step 102 may be performed by a device 2.

### Example Embodiment 2

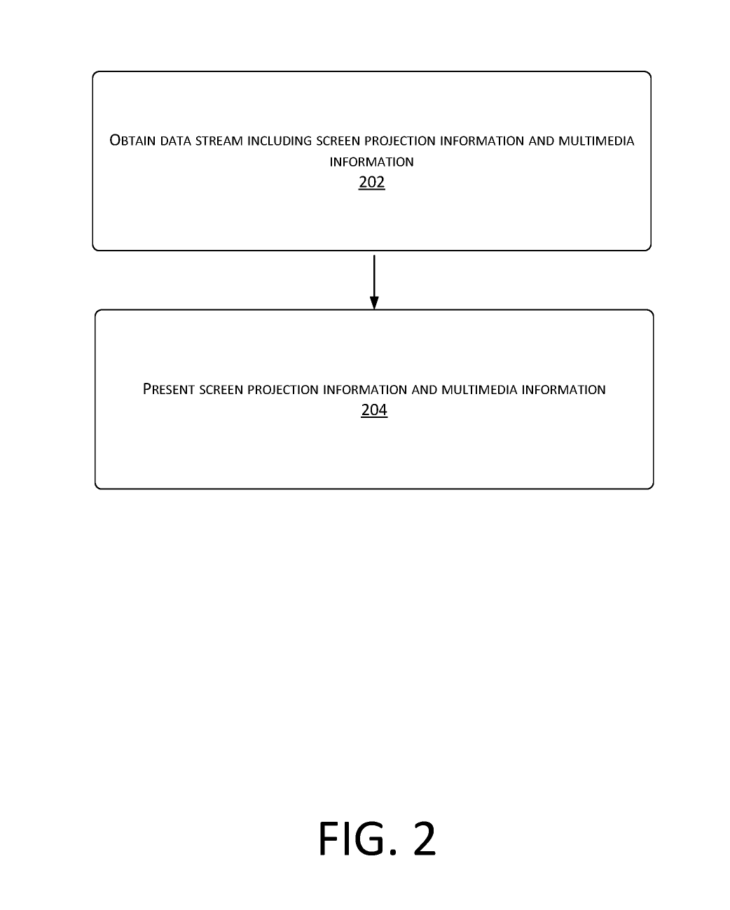

An objective is to solve the problem of relatively low sharing efficiency of a file operation process between a local user and a remote user in a teleconference process. The method may be performed by a PC, a mobile terminal, a smart television, or the like, and the present disclosure makes no limitation. A flowchart of specific implementation of the method is as shown in FIG. 2, which includes the following steps:

Step 202. A data stream including screen projection information and multimedia information is obtained.

The execution body may obtain the data stream including the screen projection information and the multimedia information during a teleconference. The multimedia information may be video information when the teleconference is a remote video conference.

Specifically, the execution body may acquire the screen projection information through a cloud-based Operating System (OS) and/or a computer screen shot technology; and may acquire the multimedia information by using one or more of the following information collection devices: a camera built in the execution body; or in combination with a third-party separate device, and the like.

Step 204. The screen projection information and the multimedia information are presented.

By using the method provided in example embodiment 2, a data stream including screen projection information and multimedia information may be obtained, and the screen projection information and the multimedia information are presented at the same time. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

It should be noted that the steps of the method provided in example embodiment 2 may all be performed by a same device, or the method may be performed by different devices. For example, step 202 may be performed by a device 1, and step 204 may be performed by a device 2; for another example, step 202 may be performed by a device 2, and step 204 may be performed by a device 1.

### Example Embodiment 3

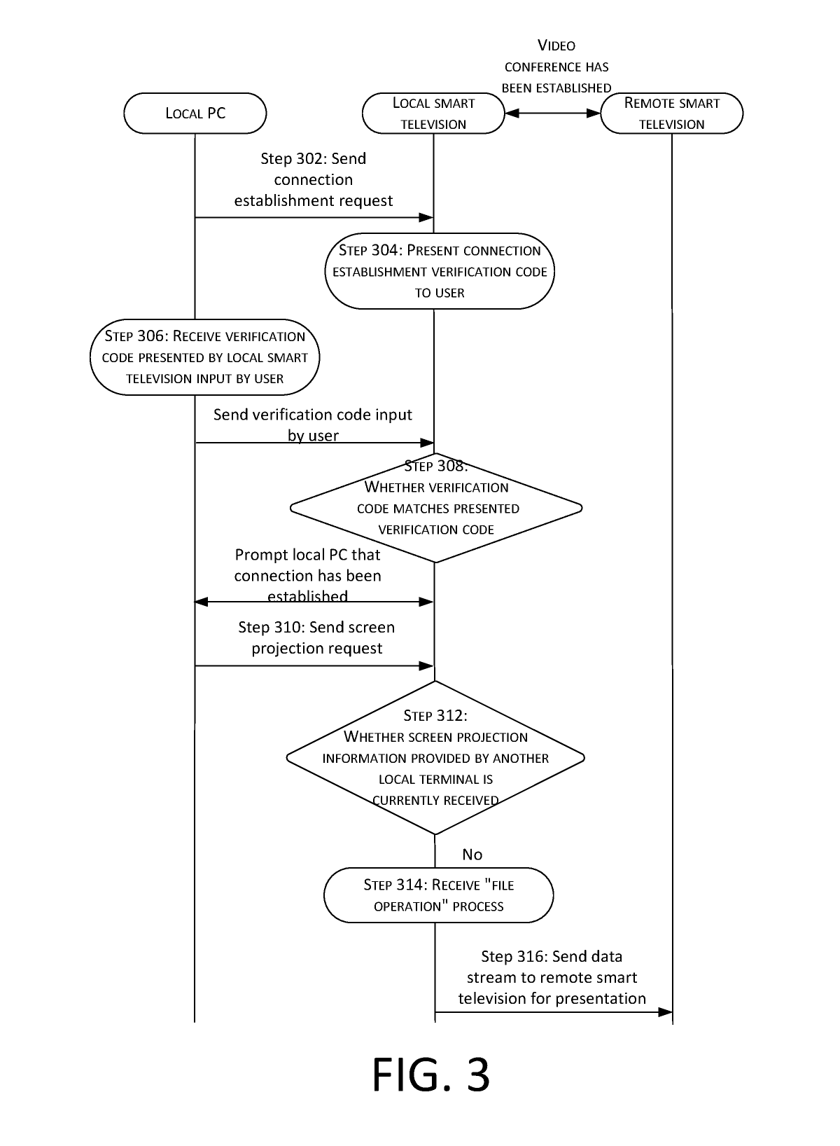

Example embodiment 3 provides a method of real-time demonstrating a “file operation” process to a remote user in a remote video conference. A schematic flowchart of implementation of the method is as shown in FIG. 3. It is assumed that a current scenario is that a remote video conference has been established between a local smart television and a remote smart television.

The method mainly includes the following steps:

Step 302. A user sends a connection establishment request to a local smart television by using a local PC.

Step 304. The local smart television receives the connection establishment request sent by the local PC, and presents a screen projection code to a user of the local PC.

Specifically, suppose that the local smart television does not establish any connection with any other local terminal device currently; then, the local smart television, after receiving the connection establishment request sent by the local PC, may display a screen projection code on a screen of the local smart television.

Step 306. The local PC receives a screen projection code presented by the local smart television input by the user, and sends the screen projection code to the local smart television.

Step 308. The local smart television, after receiving a connection establishment screen projection code sent by the local PC, judges whether the screen projection code matches the presented screen projection code, and if yes, the local smart television establishes a connection with the local PC, and prompts the local PC that the connection has been established; otherwise, the local smart television presents, to the local PC, prompt information indicating that the connection fails.

Step 310. After the local smart television establishes a connection with the local PC, the local PC sends a screen projection request to the local smart television.

Step 312. The local smart television receives the screen projection request sent by the local PC, and judges whether screen projection information provided by another local terminal is received currently; if no screen projection information provided by another local terminal is received, step 314 is performed; otherwise, prompt information “whether to switch current video information” or “refuse to receive the screen projection information” may be presented to the user of the local PC.

Step 314. The local smart television receives the screen projection information sent by the local PC. The screen projection information is screen display information generated in a file demonstration process performed by the user on the local PC.

Step 316. The local smart television combines the received screen projection information received and video information collected by a camera into a same data stream and then sends the data stream to a remote smart television for presentation.

It is assumed that the camera in step 316 is built in the smart television, and it is assumed that the collected video information is video information in a video conference with the remote smart television.

By using the method provided in example embodiment 3, information currently displayed on a display screen of a local terminal and multimedia information collected by an information collection device can be combined into a same data stream, and the data stream is sent to a receiving end for presentation. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

### Example Embodiment 4

In order to solve the problem of relatively low sharing efficiency of a file operation process between a local user and a remote user in a teleconference process, example embodiment 4 of the present disclosure provides an information presentation apparatus 400. The information presentation apparatus 400 includes one or more processor(s) 402 or data processing unit(s) and memory 404. The information presentation apparatus 400 may further include one or more input/output interface(s) 406 and one or more network interface(s) 408. The memory 404 is an example of computer readable media.

The memory 404 may store therein a plurality of modules or units including: an acquisition unit 410 and a sending unit 412 that are specifically described as follows:

The acquisition unit 410 may be configured to obtain screen projection information of a local terminal, wherein the screen projection information is information currently displayed on a display screen of the local terminal; and

the sending unit 412 may be configured to combine the obtained screen projection information and multimedia information collected by an information collection device into a same data stream, and then send the data stream to a receiving end for presentation.

In an implementation, in order to facilitate the execution body to establish a connection with the local terminal rapidly, the information presentation apparatus may further include: an output unit, a receiving unit and a connection unit.

Specifically, the output unit is configured to output a screen projection code mapped to a local address;

the receiving unit is configured to receive a screen projection request sent by the local terminal after the local terminal determines the local address according to the screen projection code; and

the connection unit is configured to establish, in response to the screen projection request, a connection with the local terminal.

The output unit may be configured to display the presented screen projection code on a display device; or broadcast the presented screen projection code.

In an implementation, the acquisition unit 410 may include: a request receiving sub-unit, a judgment sub-unit and an information receiving sub-unit.

Specifically, the request receiving sub-unit may be configured to receive a screen projection request sent by the local terminal;

the judgment sub-unit may be configured to judge whether screen projection information provided by another local terminal is received currently; and

the information receiving sub-unit may be configured to receive, when the judgment result of the judgment sub-unit is No, screen projection information provided by the local terminal.

Further, the acquisition unit 410 may be configured to obtain the screen projection information of the local terminal during a teleconference. The multimedia information is video information when the teleconference is a remote video conference.

In an implementation, the sending unit 412 may be configured to send the data stream to a remote terminal for presentation; or/and send the data stream to another local terminal for presentation.

In an implementation, the sending unit 412 may be configured to combine, according to a relative position relationship between a picture represented by the screen projection information and a picture represented by the multimedia information, the screen projection information and the multimedia information collected by the information collection device into a same data stream.

In a manner, the screen projection information may be obtained, according to a preset sampling cycle, by collecting information displayed on the display screen of the local terminal.

It should be noted that an information presentation apparatus provided in example embodiment 4 may be a smart television, a set-top box or a PC, and the present disclosure makes no limitation.

By using the apparatus provided in example embodiment 4, information currently displayed on a display screen of a local terminal and multimedia information collected by an information collection device can be combined into a same data stream, and the data stream is sent to a receiving end for presentation. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

### Example Embodiment 5

In order to solve the problem of relatively low sharing efficiency of a file operation process between a local user and a remote user in a teleconference process, example embodiment 5 of the present disclosure provides an information presentation apparatus 500. The information presentation apparatus 500 includes one or more processor(s) 502 or data processing unit(s) and memory 504. The information presentation apparatus 500 may further include one or more input/output interface(s) 506 and one or more network interface(s) 508. The memory 404 is an example of computer readable media.

The memory 504 may store therein a plurality of modules or units including: an acquisition unit 51 and a presentation unit 512 that are specifically described as follows:

The acquisition unit 510 may be configured to obtain a data stream including screen projection information and multimedia information.

The presentation unit 512 may be configured to present the screen projection information and the multimedia information.

In an implementation, the acquisition unit 510 may be configured to obtain the data stream including the screen projection information and the multimedia information during a teleconference. The multimedia information is video information when the teleconference is a remote video conference.

In an implementation, the presentation unit 512 may be configured to present the screen projection information and the multimedia information by using a same local device.

It should be noted that an information presentation apparatus provided in example embodiment 5 may be a PC, a mobile terminal or a smart television, and the present disclosure makes no limitation.

By using the apparatus provided in example embodiment 5, a data stream including screen projection information and multimedia information may be obtained, and the screen projection information and the multimedia information are presented at the same time. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

### Example Embodiment 6

In order to solve the problem of relatively low sharing efficiency of a file operation process between a local user and a remote user in a teleconference process, example embodiment 6 of the present disclosure provides an information presentation system 600, which mainly includes: a first device 610 and a second device 612 that are specifically described as follows:

The first device 610 is configured to present a screen projection code mapped to an address of the first device; and after receiving and responding to a screen projection request sent by the second device, perform information presentation according to a data stream sent by the second device.

The second device 612 is configured to obtain the screen projection code mapped to the address of the first device; and send a screen projection request to the first device after the address mapped by the screen projection code is determined; and after the first device responds to the screen projection request, combine the obtained screen projection information and the multimedia information collected by an information collection device into the data stream and send the data stream to the first device;

wherein the screen projection information is information currently displayed on a display screen of the local terminal.

By using the system provided in example embodiment 6, a data stream including screen projection information and multimedia information may be obtained, and the screen projection information and the multimedia information are presented at the same time. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

### Example Embodiment 7

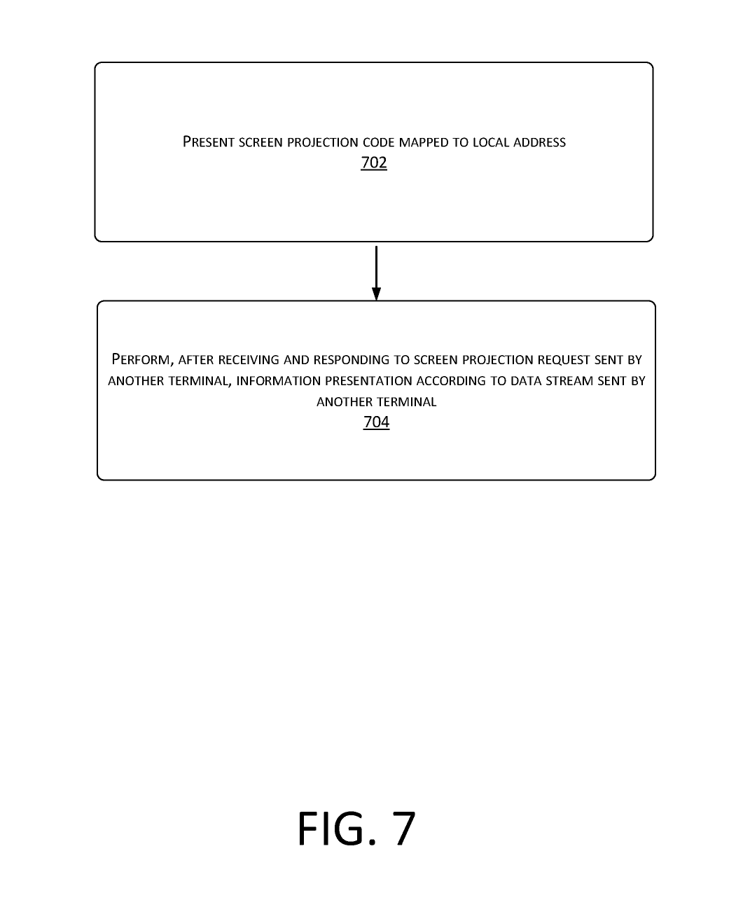

In order to solve the problem of relatively low sharing efficiency of a file operation process between a local user and a remote user in a teleconference process, a flowchart of implementation of the method is as shown in FIG. 7, which mainly includes the following steps:

Step 702. A screen projection code mapped to a local address is presented.

In the example embodiment of the present disclosure, the local address may be an IP address of a currently used wireless network when the execution body establishes a connection with a local terminal through the wireless network; here the present disclosure makes no limitation.

Step 704. After a screen projection request sent by another terminal is received and a response is made thereto, information presentation is performed according to a data stream sent by the another terminal.

The data stream includes screen projection information and multimedia information collected by an information collection device; the screen projection information is information currently displayed on a display screen of the another terminal.

By using the method provided in example embodiment 7, a data stream including screen projection information and multimedia information may be obtained, and the screen projection information and the multimedia information are presented at the same time. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

It should be noted that the steps of the method provided in example embodiment 7 may all be performed by a same device, or the method may be performed by different devices. For example, step 702 may be performed by a device 1, and step 704 may be performed by a device 2; for another example, step 704 may be performed by a device 1, and step 702 may be performed by a device 2.

### Example Embodiment 8

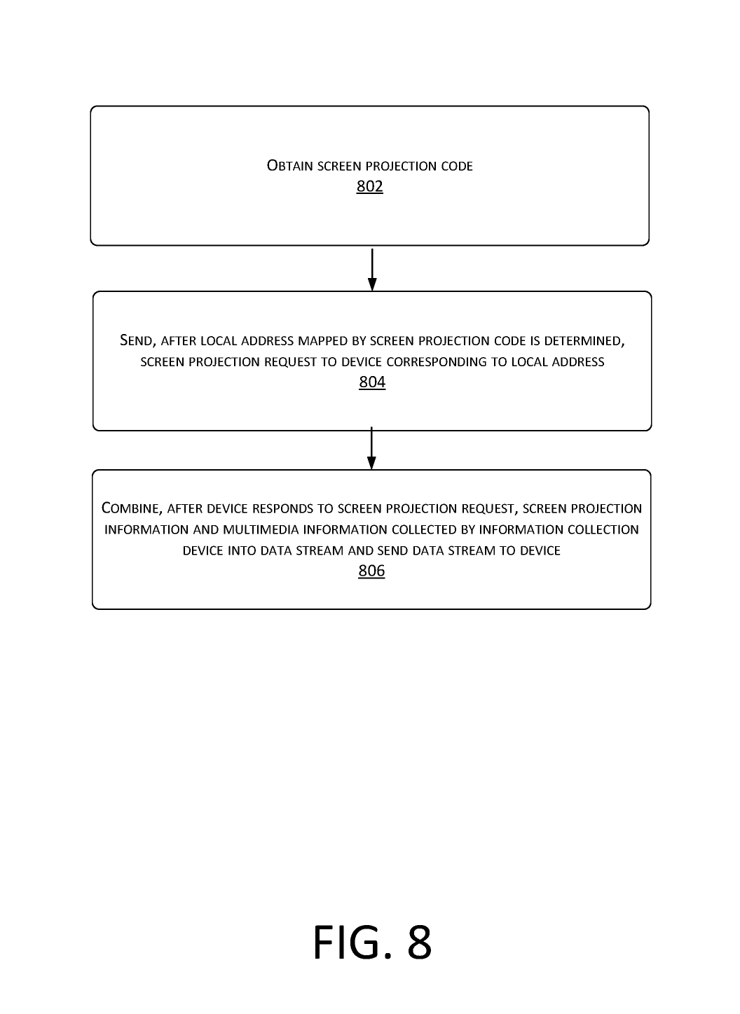

In order to solve the problem of relatively low sharing efficiency of a file operation process between a local user and a remote user in a teleconference process, a flowchart of implementation of the method is as shown in FIG. 8, which mainly includes the following steps:

Step 802. A screen projection code is obtained.

Step 804. After a local address mapped by the screen projection code is determined, a screen projection request is sent to a device corresponding to the local address.

Step 806. After the device responds to the screen projection request, the screen projection information and multimedia information collected by an information collection device are combined into a data stream and the data stream is sent to the device.

By using the method provided in example embodiment 8, a data stream including screen projection information and multimedia information may be obtained, and the screen projection information and the multimedia information are presented at the same time. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

It should be noted that the steps of the method provided in example embodiment 8 may all be performed by a same device, or the method may be performed by different devices. For example, step 802 and step 804 may be performed by a device 1, and step 806 may be performed by a device 2; for another example, step 806 may be performed by a device 1, and step 802 and step 804 may be performed by a device 2, and so on.

### Example Embodiment 9

In order to solve the problem of relatively low sharing efficiency of a file operation process between a local user and a remote user in a teleconference process, example embodiment 9 of the present disclosure provides an information presentation apparatus 900. The information presentation apparatus 900 includes one or more processor(s) 902 or data processing unit(s) and memory 904. The information presentation apparatus 900 may further include one or more input/output interface(s) 906 and one or more network interface(s) 908. The memory 904 is an example of computer readable media.

The memory 904 may store therein a plurality of modules or units including: a presentation unit 910 and a receiving unit 912 that are specifically described as follows:

The presentation unit 910 is configured to present a screen projection code mapped to a local address; and

the receiving unit 912 is configured to perform, after receiving and responding to a screen projection request sent by another terminal, information presentation according to a data stream sent by the another terminal.

The data stream includes screen projection information and multimedia information collected by an information collection device; and the screen projection information is information currently displayed on a display screen of the another terminal.

By using the apparatus provided in example embodiment 9, a data stream including screen projection information and multimedia information may be obtained, and the screen projection information and the multimedia information are presented at the same time. Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

### Example Embodiment 10

In order to solve the problem of relatively low sharing efficiency of a file operation process between a local user and a remote user in a teleconference process, example embodiment 10 of the present disclosure provides an information presentation apparatus 1000. The information presentation apparatus 1000 includes one or more processor(s) 1002 or data processing unit(s) and memory 1004. The information presentation apparatus 1000 may further include one or more input/output interface(s) 1006 and one or more network interface(s) 1008. The memory 1004 is an example of computer readable media.

The memory 1004 may store therein a plurality of modules or units including: an acquisition unit 1010, a determination unit 1012 and a sending unit 1014 that are specifically described as follows:

The acquisition unit 1010 is configured to obtain a screen projection code.

The determination unit 1012 is configured to send, after determining a local address mapped by the screen projection code, a screen projection request to a device corresponding to the local address.

The sending unit 1014 is configured to combine, after the device responds to the screen projection request, the screen projection information and multimedia information collected by an information collection device into a data stream and send the data stream to the device.

By using the apparatus provided in example embodiment 10, a data stream including screen projection information and multimedia information may be obtained, and the screen projection information and the multimedia information are presented at the same time.

Therefore, when the solution is applied to a teleconference process, automatic sharing of a file operation process can be achieved while transmission of the multimedia information is supported, which does not require manual cooperation of a remote user and solves the problem of relatively low sharing efficiency of the file operation process between a local user and a remote user in the teleconference process.

Those skilled in the art should understand that, the example embodiments of the present disclosure may be provided as a method, a system, or a computer program product. Therefore, the present disclosure may be implemented as a complete hardware example embodiment, a complete software example embodiment, or an example embodiment combining software and hardware. Moreover, the present disclosure may be in the form of a computer program product implemented on one or more computer usable storage media (including, but not limited to, a magnetic disk memory, a CD-ROM, an optical memory, and the like) including computer usable program code.

The present disclosure is described with reference to flowcharts and/or block diagrams according to the method, the device (system), and the computer program product of the example embodiments of the present disclosure. It should be understood that a computer program instruction may be used to implement each process and/or block in the flowcharts and/or block diagrams and combinations of processes and/or blocks in the flowcharts and/or block diagrams. The computer program instructions may be provided to a general-purpose computer, a special-purpose computer, an embedded processor or a processor of another programmable data processing device to generate a machine, such that the computer or the processor of another programmable data processing device executes an instruction to generate an apparatus configured to implement functions designated in one or more processes in a flowchart and/or one or more blocks in a block diagram.

The computer program instructions may also be stored in a computer readable storage that can guide the computer or another programmable data processing device to work in a specific manner, such that the instruction stored in the computer readable storage generates an article of manufacture including an instruction apparatus, and the instruction apparatus implements functions designated by one or more processes in a flowchart and/or one or more blocks in a block diagram.

The computer program instructions may also be loaded into a computer or another programmable data processing device, such that a series of operation steps are executed on the computer or another programmable device to generate computer implemented processing, and therefore, the instruction executed in the computer or another programmable device provides steps for implementing functions designated in one or more processes in a flowchart and/or one or more blocks in a block diagram.

In a typical configuration, the computing device includes one or more processors (CPU), an input/output interface, a network interface, and a memory.

The memory may include a volatile memory, a random access memory (RAM) and/or a non-volatile memory or the like in a computer readable medium, for example, a read-only memory (ROM) or a flash RAM. The memory is an example of the computer readable medium.

The computer readable media include non-volatile and volatile media as well as movable and non-movable media, and can implement information storage by means of any method or technology. Information may be a computer readable instruction, a data structure, and a module of a program or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission media, and can be used to store information accessible to the computing device. According to the definition herein, the computer readable media do not include transitory media, such as modulated data signals and carriers.

It should be further noted that the terms “include”, “comprise” or other variations thereof are intended to cover non-exclusive inclusion, so that a process, method, commodity or device including a series of elements not only includes the elements, but also includes other elements not clearly listed, or further includes inherent elements of the process, method, commodity or device. In the absence of more limitations, an element defined by “including a/an . . . ” does not exclude that the process, method, commodity or device including the element further has other identical elements.

Those skilled in the art should understand that, the example embodiments of the present disclosure may be provided as a method, a system, or a computer program product. Therefore, the present disclosure may be implemented as a complete hardware example embodiment, a complete software example embodiment, or an example embodiment combining software and hardware. Moreover, the present disclosure may be in the form of a computer program product implemented on one or more computer usable storage media (including, but not limited to, a magnetic disk memory, a CD-ROM, an optical memory, and the like) including computer usable program code.

The above descriptions are merely example embodiments of the present disclosure, but are not intended to limit the present disclosure. For those skilled in the art, the present disclosure may have various modifications and changes. Any modification, equivalent replacement, improvement and the like made within the spirit and principle of the present disclosure should all be included in the scope of the claims of the present disclosure.

What is claimed is:

1. A method comprising:
outputting, by a first terminal, a screen projection code mapped to the first terminal;
receiving a screen projection request sent by a second terminal,
establishing a connection between the first terminal and the second terminal.

2. The method of claim 1, wherein:
the first terminal includes a first computer, a smart TV, a set-top box, or a projector; and
the second terminal includes a second computer or a portable device.

3. The method of claim 1, wherein the outputting the screen projection code mapped to the first terminal includes:
generating, by the first terminal, the screen projection code; and
displaying the screen projection code on a screen of the first terminal.

4. The method of claim 1, wherein the outputting the screen projection code mapped to the first terminal includes:
receiving, by the first terminal, the screen projection code from a server; and
displaying the screen projection code on a screen of the first terminal.

5. The method of claim 1, wherein the outputting the screen projection code mapped to the first terminal includes:
broadcasting the screen projection code.

6. The method of claim 1, wherein the screen projection code mapped to an address of the first terminal that locates the first terminal.

7. The method of claim 6, wherein the address of the first terminal is an IP address of the first terminal.

8. The method of claim 1, further comprising:
receiving screen projection information of the second terminal; and
displaying the screen projection information at a screen of the first terminal.

9. The method of claim 1, further comprising:
receiving a data stream including screen projection information of the second terminal and multimedia information collected by an information collection device; and
displaying the data stream at the screen of the first terminal.

10. The method of claim 9, wherein the screen projection information is information currently displayed on a display screen of the second terminal.

11. The method of claim 9, wherein the multimedia information is video information when there is a remote video conference between the first terminal and the second terminal.

12. The method of claim 1, wherein a distance between the first terminal and the second terminal is smaller than a threshold.

13. The method of claim 1, wherein a distance between the first terminal and the second terminal is larger than a threshold.

14. A method comprising:
receiving, by a second terminal, a first screen projection code mapped to a first terminal;
determining the first terminal according to the first screen projection code;
sending a first screen projection request from the second terminal to the first terminal; and
establishing a first connection between the first terminal and the second terminal.

15. The method of claim 14, further comprising:
obtaining screen projection information of the second terminal device;
obtaining multimedia information collected by an information collection device;
combining the screen projection information and multimedia information into a data stream; and
sending the data stream to the first terminal.

16. The method of claim 15, wherein the combining the screen projection information and the multimedia information into the data stream includes:
combining, according to a relative position relationship between a picture represented by the screen projection information and a picture represented by the multimedia information, the screen projection information and the multimedia information collected by the information collection device into the data stream.

17. The method of claim 14, further comprising:
receiving a second screen projection code mapped to a third terminal by a second terminal;
determining the third terminal according to the second screen projection code;
sending a second screen projection request from the second terminal to the third terminal; and
establishing a second connection between the first terminal and the second terminal.

18. The method of claim 17, wherein the establishing the second connection between the first terminal and the second terminal includes establishing the first connection and the second connection concurrently.

19. The method of claim 14, wherein a distance between the first terminal and the second terminal is smaller or larger than a threshold.

20. An apparatus comprising:
one or more processors; and
one or more memories stored thereon computer readable instructions that, when executed by one or more processors, cause the one or more processors to perform acts comprising:
outputting, by a first terminal, a screen projection code mapped to the first terminal;
receiving a screen projection request sent by a second terminal,
establishing a connection between the first terminal and the second terminal;
receiving screen projection information of the second terminal; and
displaying the screen projection information at a screen of the first terminal.
